(19) United States
(12) Patent Application Publication
(10) Pub. No.: US 2007/0101254 A1
(43) Pub. Date: May 3, 2007

(54) Systems and methods for providing an allowed input range in a user interface

(76) Inventor: Jon R. Sawyer, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/264,619

(22) Filed: Oct. 31, 2005

(51) Int. Cl. G06F 17/00; G06F 3/00

(52) U.S. Cl. 715/507; 715/764

(57) ABSTRACT

Systems and methods are disclosed for validating one or more inputs to a user interface. In one embodiment, a system for providing an allowed input range in a user interface window is provided with a window creator to receive a document transferred between a server and a user interface. The document includes a set of data objects and at least one rule for the allowed input range. The window creator creates the user interface window to correspond to a selected one of the set of data objects and the at least one rule for the allowed input range, such that the user interface window provides the allowed input range for the selected one of the data objects. The allowed input range is determined by the data object received from the document and the at least one rule received from the document.

### BACKGROUND

When developing a user interface, the software developer must ensure that values entered by the user are valid according to the policies and the current state of an application.

Generally, a mechanism for validating the application object model is separate from the user interface. Either the use interface developer must replicate this logic in the user interface or invoke the validation mechanism after the user has entered values.

Typically, a user interface developer will duplicate the logic from the validation mechanism in the user interface. For example, the allowed choices for an enumerated value are programmed in the user interface into a list from which the user may select. This duplicated logic creates maintenance problems. When the allowed list of enumerated values changes in the validation mechanism, the developer must remember to change the related user interface code as well. If this is overlooked, defects may result in the program.

Another solution is to allow the user to enter any value, and subsequently invoke the validation mechanism after entry. There is no duplicated logic but the user interface is much harder to use because the user may not be aware of the range of valid values, and must resort to trial and error to find values that pass the subsequent invocation of validation mechanism.

### SUMMARY OF THE INVENTION

In one embodiment, there is provided a system for providing an allowed input range in a user interface window, the system comprising a window creator to receive a document transferred between a server and the user interface, wherein the document comprises a set of data objects and at least one rule for the allowed input range, wherein the window creator creates the user interface window to correspond to a selected one of the set of data objects and the at least one rule for the allowed input range, wherein the user interface window provides the allowed input range for the selected one of the data objects, and wherein the allowed input range is determined by the data object received from the document and the at least one rule received from the document.

In another embodiment, there is provided a method for providing an allowed input range in a user interface. The method comprises receiving a document from a server at the user interface, the document having a set of data objects, and at least one rule for the allowed input range; receiving a selected one of the data objects from the document in a window creator; obtaining the at least one rule in the document using the window creator; and creating a user interface window with the window creator, wherein the user interface window provides the allowed input range for the selected one of the data objects based on attributes of the selected one of the data objects and the at least one rule transmitted to the window creator.

Other embodiments are also disclosed.

### BRIEF DESCRIPTION OF THE DRAWINGS

Illustrative embodiments of the invention are illustrated in the drawings, in which:

FIG. 1 is a diagrammatic illustration of a system according to one embodiment, the system including a server and a user interface, in communication with one another via a document;

FIG. 2 is a diagrammatic illustration of the document shown in FIG. 1, the document including a set of data objects arranged in a stack, with each one of the data objects having a set of data types, a set of rules, and a rule map linking each one of the data types to one or more of the rules;

FIG. 3 is a diagrammatic illustration of a system according to another embodiment, the system including the document, shown in FIGS. 1 and 2, and the user interface shown in FIG. 1, in which there is provided a window creator, a user interface description, a window created for a selected one of the data objects, and a window validator;

FIGS. 4-8 are flow diagrams illustrating various exemplary methods for providing an allowed input range in a user interface.

### DETAILED DESCRIPTION OF AN EMBODIMENT

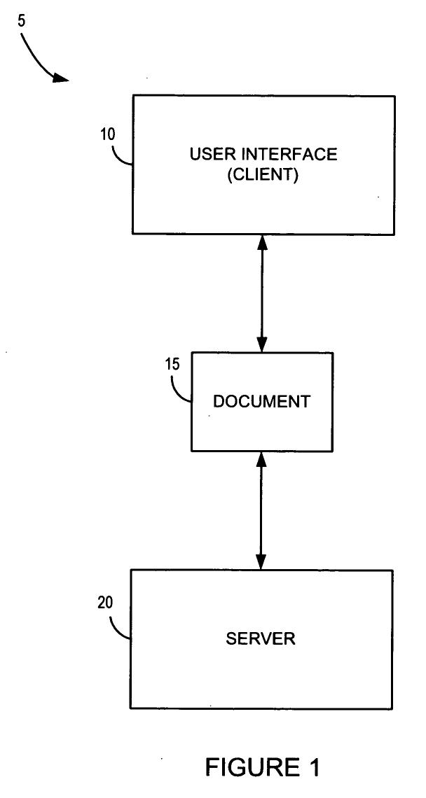

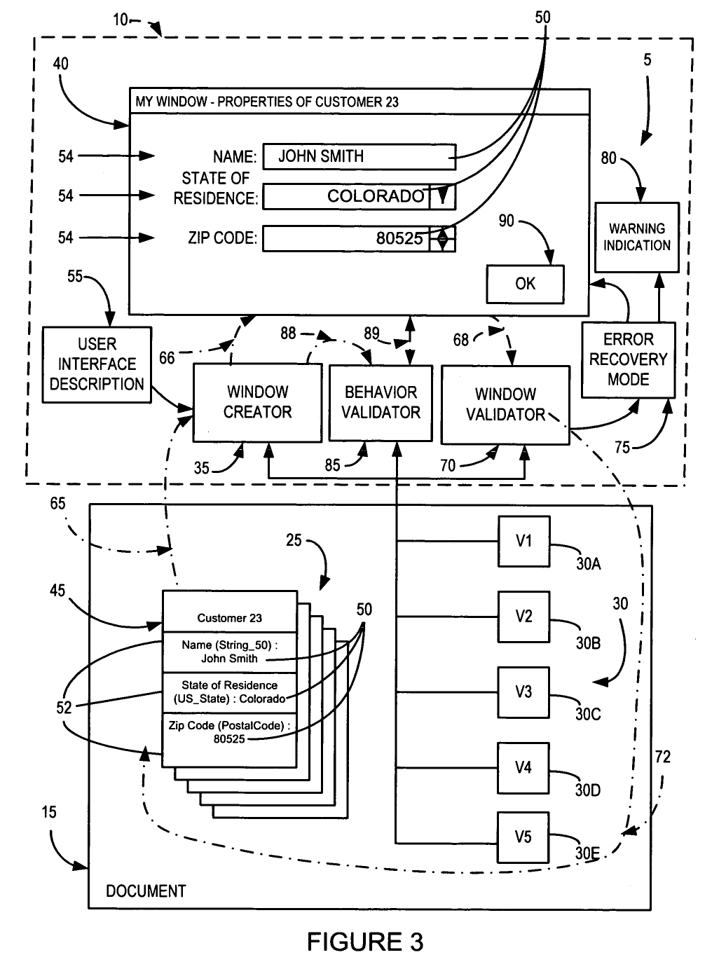

Referring to FIGS. 1-3, and in one embodiment, there is shown a system 5 for providing an allowed input range in a user interface 10 (FIGS. 1 and 3). For example, the allowed input range may be provided with a text box with a set number of characters, a drop down list of items, or a scrolling set of items.

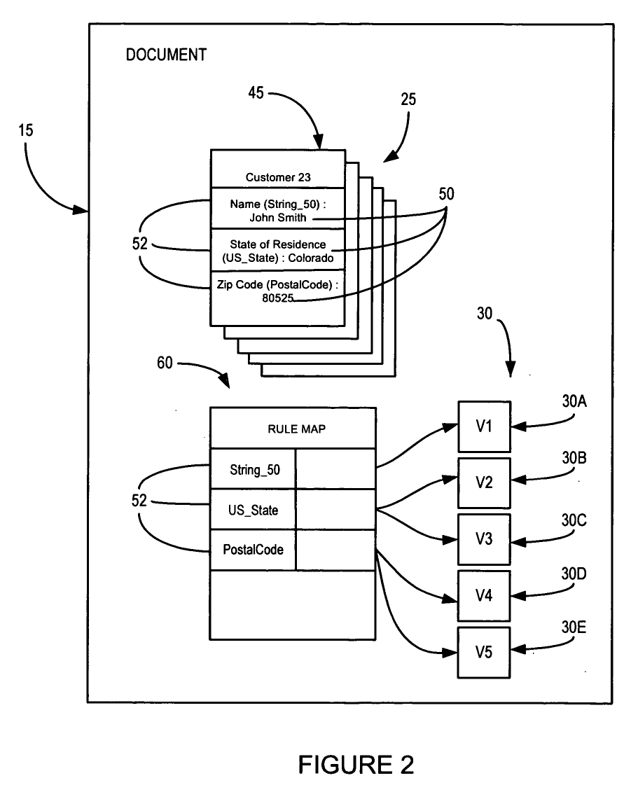

In one embodiment, system 5 includes a document 15 transmitted between a server 20 and user interface 10. Looking at FIG. 2, document 15 has a set of data objects 25 and at least one rule 30 for an allowed input range to the document 15. In one embodiment, rules 30A, 30B, 30C, 30D and 30E form a set of at least one rule 30.

Looking at FIG. 3, there is shown a window creator 35 for creating a user interface window 40 corresponding to a selected one 45 of the data objects 25. In an embodiment, user interface window 40 provides the allowed input range for the selected one 45 of the data objects 25. The allowed input range may be determined by the selected one 45 of the data objects 25 received from the document 15, and from the rules 30 received from the document 15.

In one embodiment, and looking at FIGS. 2 and 3, each one of data objects 25 may have a set of attributes 50, each of which includes data types 52. Referring now to FIG. 2, each one of attributes 50 of data objects 25 may be mapped to corresponding ones of rules 30A, 30B, 30C, 30D and 30E, which form the set of at least one rule 30.

Referring again to FIG. 3, window creator 35 may comprise code to receive selected one 45 of data objects 25 from document 15. In an embodiment, window creator 35 may comprise code to receive one or more of rules 30A, 30B, 30C, 30D and 30E, which form the set of at least one rule 30. Window creator 35 may comprise code to create user interface window 40 for selected one 45 of data objects 25.

In one embodiment, and referring still to FIG. 3, there is shown a user interface description 55 which may provide a generalized structure of user interface window 40. Window creator 35 may be programmed to receive user interface description 55, and window creator 35 may be programmed to create window 40 for selected one 45 of data objects 25 based on data object 25 received from document 15, the at least one rule 30, which may include one or more of rules 30A, 30B, 30C, 30D and 30E received from document 15, and user interface description 55. In one embodiment, user interface description 55 may comprise a XML file.

Referring to FIGS. 2 and 3, and in one embodiment, a set of input fields 54 may be provided for data objects 25. In one embodiment, a rule map 60 (FIG. 2) may be provided to relate each one of data types 52 to one or more rules 30. In one embodiment, a set of initial values for attributes 50 for the selected one 45 of data objects 25 are transferred 65 from document 15 to window creator 35. In one embodiment, the set of initial values for attributes 50 for the selected one 35 of data objects 25 are transferred 66 from window creator 35 to user interface window 40. Optionally, user interface description 55, together with the set of initial values for attributes 50, are transferred 66 from window creator 35 to user interface window 40.

Referring now to FIG. 3, and in one embodiment, there is shown a window validator 70 for validating chosen values of each attribute 50 in input field 54 for selected one 45 of data objects 25 from user interference window 40. Typically, the chosen values are selected or entered by the user. Window validator 70 may receive 68 chosen values of the set of attributes 50 from user interface window 40. Window validator 70 may receive at least one rule 30 from document 15. Window validator 70 may be programmed to analyze the chosen values of attributes 50 from user interface 10 with respect to at least one rule 30 from document 15 so as to validate that the chosen values are within the allowed input range.

Referring still to FIG. 3, and in one embodiment, window validator 70 may comprise code to transfer 72 chosen values of the set of attributes 50 of selected one 45 of data objects 25 from window validator 70 to document 15 when the chosen values are successfully validated. In one embodiment, the chosen values for selected one 45 of data objects 25 may be stored in document 15 as a set of updated values of selected data object 45, to replace a set of initial values of attributes 50.

In one embodiment, an error recovery mode 75 may be invoked by window validator 70 when the chosen values are not valid. In one embodiment, window validator 70 may comprise code to create a warning indication 80 in user interface 10 when the chosen values are not valid. In another embodiment, window validator 70 may comprise code to transfer the chosen values back to user interface window 40. In yet another embodiment, window validator 70 may comprise code to discard the chosen values for attributes 50 when the chosen values are not validated so as to prevent the chosen values from being stored in document 15 as a set of updated values of attributes 50 to replace a set of initial values of attributes 50.

Referring to FIG. 3, a behavior validator 85 may be provided to initiate validation of the chosen values of attributes 50 to and from user interface window 40. In one embodiment, behavior validator 85 may be invoked by a button 90.

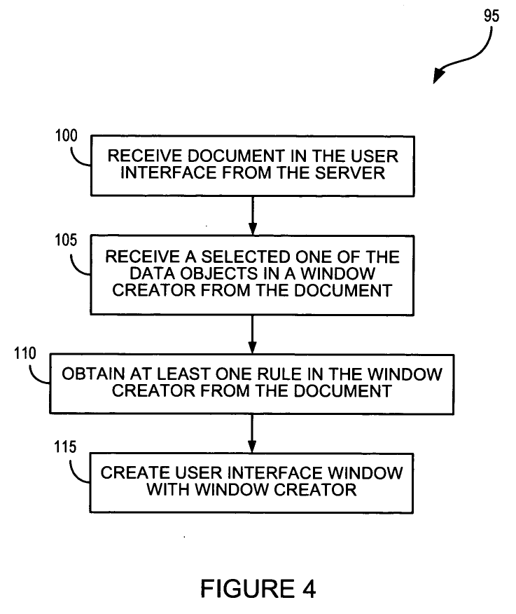

Referring now to FIG. 4, and in an embodiment, there is shown a method 95 for providing an allowed input range in user interface 10. Method 95 may comprise receiving 100 document in the user interface from a server. The document may have a set of data objects, and at least one rule for the allowed input range. Method 95 may comprise receiving a selected one 45 of the data objects in the window creator from the document. Method 95 may include obtaining 110 at least one rule from the document in window creator 35 from the document. Method 95 may include creating 115 a user interface window with the window creator. The user interface window may provide the allowed input range for input fields of the selected one of the data objects based on the selected one of the data objects and at least one rule transmitted to the window creator.

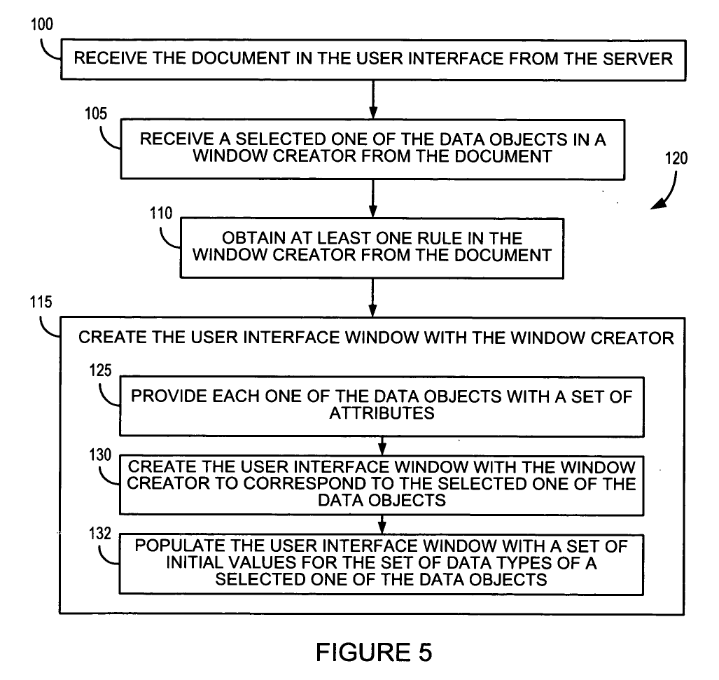

Referring to FIG. 5, and in an embodiment, there is provided a method 120 for providing an allowed input range in the user interface, in which the step of creating 115 the user interface window may further comprise providing 125 each one of data objects with a set of attributes. Each one of attributes of the data objects may be mapped to corresponding ones of at least one rule. Method 120 may further comprise creating 130 the user interface window with the window creator to correspond to the selected one of data objects so as to provide the allowed input range for each of data types received from document 15 and at least one rule 30 received from document 15.

In an embodiment, method 95 or method 120 may further comprise populating 132 user interface window with a set of initial values for set of attributes 50 of the selected one of the data objects.

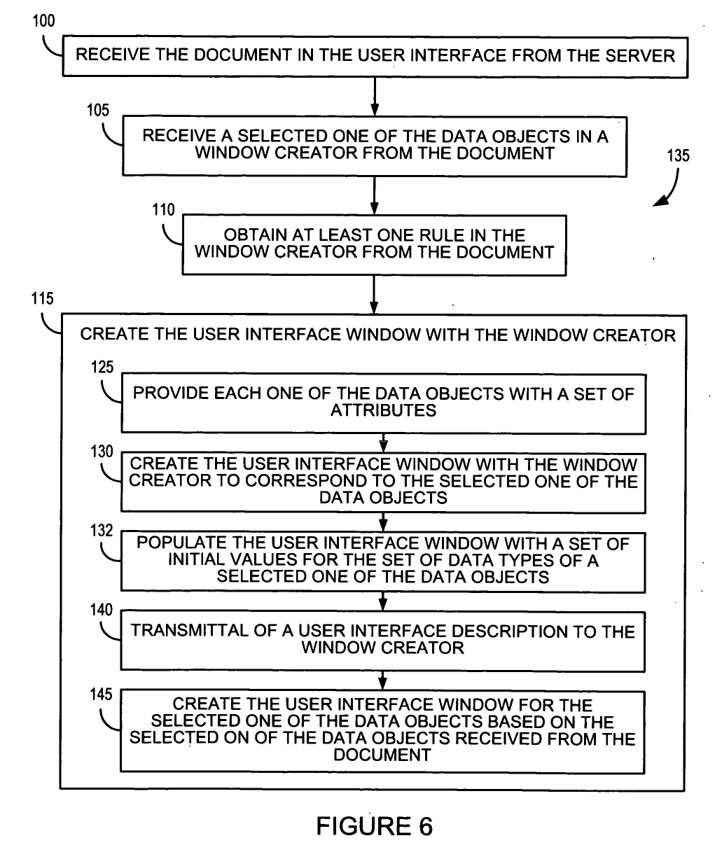

Referring now to FIG. 6, and in an embodiment, there is shown a method 135 for transmittal of a user interface description to provide an allowed input range in a user interface, which includes providing an allowed input range in the user interface, in which the step of creating the user interface window may further comprise providing each one of data objects with a set of data types and may further comprise transmittal 140 of a user interface description to the window creator. Method 135 may further comprise creating 145 the user interface window for the selected one of the data objects based on the selected one of the data objects received from the document, at least one rule received from document, and the user interface description.

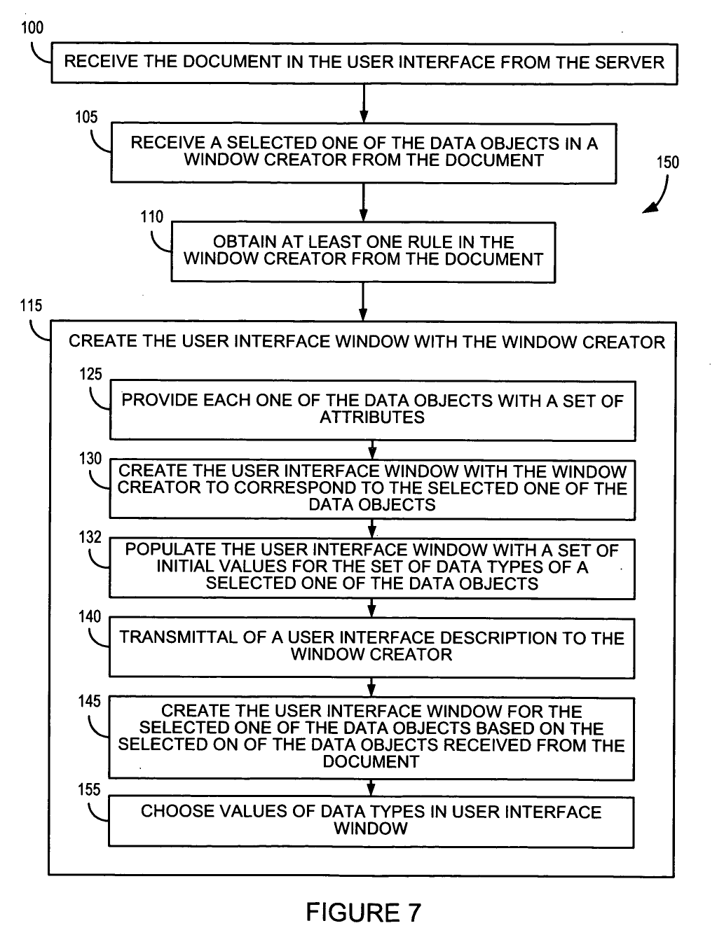

Referring to FIG. 7, and in an embodiment, there is shown a method 150 for providing an allowed input range in user interface which includes transmittal of a user interface description to provide an allowed input range in a user interface, which includes providing an allowed input range in the user interface, in which the step of creating the user interface window may further comprise providing each one of data objects with a set of data types and may further comprise choosing 155 values of input fields in the user interface window.

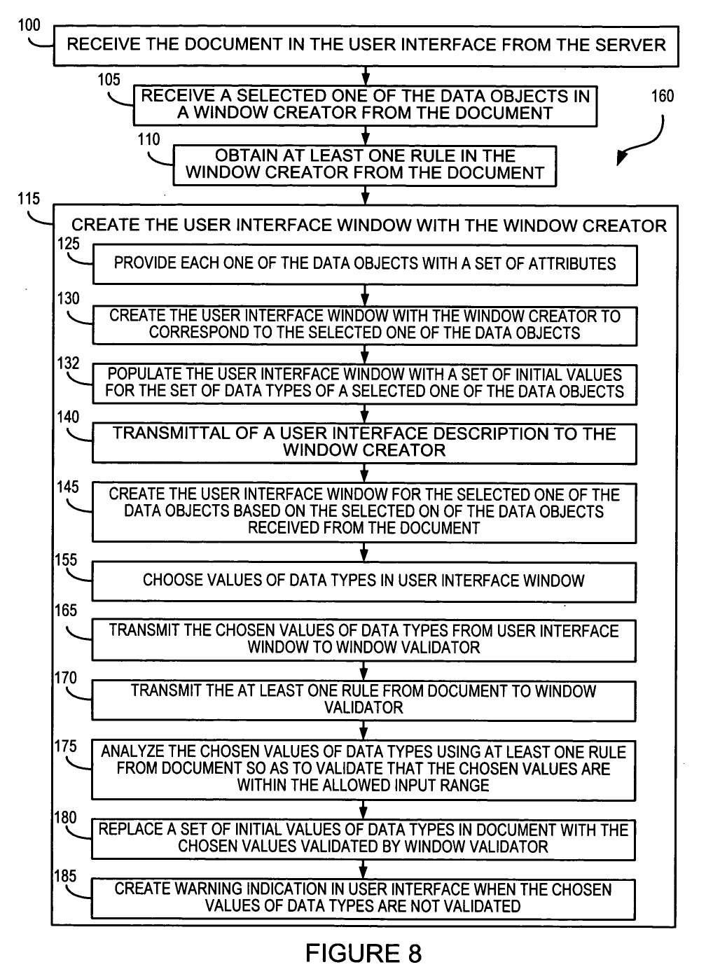

Referring to FIG. 8, and in an embodiment, there is shown a method 160 for providing an allowed input range in user interface which includes transmittal of a user interface description to provide an allowed input range in user interface which includes providing an allowed input range in the user interface in which the step of creating the user interface window may further comprise providing each one of data objects with a set of data types and choosing values of input fields in the user interface window and may further comprise transmitting 165 the chosen values of the input fields from the user interface window to the window validator. Method 160 may further comprise transmitting 170 the at least one rule from the document to the window validator.

Method 160 may further comprise analyzing 175 the chosen values of the input fields using at least one rule from the document so as to validate that the chosen values are within the allowed input range. Method 160 may further comprise replacing 180 a set of initial values of the input fields in the document with the chosen values validated by the window validator. Method 160 may further comprise creating 185 a warning indication in the user interface when the chosen values of the input fields are not valid.

In one embodiment, system 5 provides user interface 10 for a user interface developer to allow a user to select from an allowed input range of valid values for attributes 50. Generally, a well-defined programming interface is provided to allow user interface 40 to query a behavior validator 85, or window validator 70, for the allowed range for a particular value of input field 54. In one embodiment, data objects 25 may be transferred 88 from window creator 35 to behavior validator 85. Furthermore, data objects 25 may be transferred 89 between user interface window 40 and behavior validator 85.

In an embodiment, there may be defined a generic set of data types 52. These data types 52 may include, for example, an enumerated type and an ordinal range. Behavior validator 85 is constructed with knowledge of data types 52, and validation rules 30A, 30B, 30C, 30D and 30E are implemented using data types 52.

In addition, rule map 60 (FIG. 2) is provided for user interface 10 to look up the applicable validation rules for a particular variable, e.g., a property of data object 25. Rule map 60 may also perform some operations on one or more rules 30.

When user interface 10 needs to present a variable for one of data types 52 to the user, rule map 60 may be used to look up the valid range for the variable. For example, for an enumerated type variable for one of data types 52 displayed in a selectable list, user interface 10 may populate the selectable list with the allowed values returned from query mechanism 85.

When a query is made to determine the allowed values, rule map 60 may locate all applicable validation rules 30. In an embodiment, there may be many such rules 30, each one enforcing a different application policy. Some rules 30 may be statically defined. Others rules 30 may be dynamically defined to depend on the current state of system 5 to determine the currently allowed values. Query mechanism 85 returns an input range that satisfies each of the applicable validation rules 30. In an enumerated type example, set arithmetic may be used to determine an intersection of the allowed values of all applicable validation rules 30.

In an embodiment, system 5 does not require separate sets of validation logic containing validation rules 30, to be stored at server 20 and user interface 10. System 5 eliminates the potential for defects due to a programmer changing the validation logic in one place, such as server 20, without changing the validation logic in another, such as interface 10.

In addition, user interface 10 may preferably constrain the entry of values of attributes 50 to an allowed input range. Generally, system 5 prevents a “trial and error” data entry problem for selecting values of attributes 50.

In addition, system 5 provides a reusable implementation of window creator 35 that combines the entry ranges of attributes 50 from multiple validation rules 30 into allowed input range in user interface 10. As system 5 may be used repeatedly, increased developer productivity may be achieved.

In addition, system 5 provides a reusable implementation of window validator 70 that analyzes the chosen values of attributes 50 from user interface window 40 with respect to at least one rule 30 from document 15 so as to validate that the chosen values are within the allowed input range. As system 5 may be used repeatedly, increased developer productivity may be achieved.

In addition, system 5 provides a reusable implementation of behavior validator 85 that analyzes the chosen values of attributes 50 from user interface window 40 with respect to at least one rule 30 from document 15 so as to validate that the chosen values are within the allowed input range. As system 5 may be used repeatedly, increased developer productivity may be achieved.

In an embodiment, system 5 may be implemented using the Java object-oriented programming language.

What is claimed is:

1. A system for providing an allowed input range in a user interface window, the system comprising:
a window creator to receive a document transferred between a server and a user interface, wherein the document comprises a set of data objects and at least one rule for the allowed input range, wherein the window creator creates the user interface window to correspond to a selected one of the set of data objects and the at least one rule for the allowed input range, wherein the user interface window provides the allowed input range for the selected one of the data objects, and wherein the allowed input range is determined by the data object received from the document and the at least one rule received from the document.

2. The system of claim 1, wherein each one of the data objects has a set of attributes, and wherein each one of the attributes of the data objects is mapped to corresponding ones of the at least one rule.

3. The system of claim 1, wherein the window creator comprises code to receive the selected one of the data objects from the document, wherein the window creator comprises code to receive each of the at least one rule from the document, and wherein the window creator comprises code to create the user interface window for the selected one of the data objects.

4. The system of claim 1, further comprising a user interface description, wherein the window creator is programmed to receive the user interface description, and wherein the window creator is programmed to create the window for the data object based on the data object received from the document, the at least one rule received from the document, and the user interface description.

5. The system of claim 4, wherein the user interface description is a XML file.

6. The system of claim 1, further comprising a set of input fields for the data objects.

7. The system of claim 6, wherein the selected one of the data objects comprises a set of initial values for the set of input fields.

8. The system of claim 6, further comprising a window validator, separate from the window creator, to validate chosen values of a set of attributes for the selected one of the data objects from the user interference window, the window validator receiving the chosen values of the set of attributes from the user interface window, the window validator receiving the at least one rule from the document, and the window validator being programmed to analyze the chosen values of the attributes received from the user interface window with respect to the at least one rule from the document so as to validate that the chosen values are within the allowed input range.

9. The system of claim 8, wherein the window validator comprises code to send the chosen values of the set of attributes of the selected one of the data objects to the document when the chosen values are successfully validated.

10. The system of claim 9, wherein the chosen values are stored in the document as a set of updated values to replace a set of initial values of the attributes.

11. The system of claim 8, further comprising an error recovery mode, invoked by the window validator when the chosen values are not valid.

12. The system of claim 8, wherein the window validator comprises code to prompt a user when the chosen values are not valid.

13. The system of claim 8, wherein the window validator comprises code to discard the chosen values when the chosen values are not validated, so as to prevent the chosen values from being stored in the document as a set of updated values to replace a set of initial values of the attributes.

14. The system of claim 8, further comprising a behavior mechanism to initiate validation of the chosen values to and from the user interface window.

15. The system of claim 14, wherein the user interface window comprises a button to initiate a query of the behavior mechanism.

16. A method for providing an allowed input range in a user interface, the method comprising:
receiving a document from a server at the user interface, the document having a set of data objects, and at least one rule for the allowed input range;
receiving a selected one of the data objects from the document in a window creator;
obtaining the at least one rule in the document using the window creator; and
creating a user interface window with the window creator, wherein the user interface window provides the allowed input range for input fields of the selected one of the data objects based on attributes of the selected one of the data objects and the at least one rule transmitted to the window creator.

17. The method of claim 16, further comprising creating the user interface window with the window creator to correspond to the selected one of the data objects so as to provide the allowed input range for each of a set of attributes received from the document and the at least one rule received from the document.

18. The method of claim 17, further comprising populating the user interface window with a set of initial values for the set of attributes of the selected one of the data objects.

19. The method of claim 17, further comprising transmitting a user interface description to the window creator, and creating the user interface window for the selected one of the data objects based on the selected one of the data objects received from the document, the at least one rule received from the document, and the user interface description.

20. The method of claim 19, further comprising choosing values of the input fields in the user interface window.

21. The method of claim 20, further comprising transmitting the chosen values of the input fields from the user interface window to a window validator.

22. The method of claim 21, further comprising transmitting the at least one rule from the document to the window validator.

23. The method of claim 22, further comprising analyzing the chosen values of the input fields using the at least one rule from the document so as to validate that the chosen values are within the allowed input range.

24. The method of claim 23, further comprising replacing a set of initial values of the input fields in the document with the chosen values validated by the window validator.

25. The method of claim 23, further comprising creating a warning indication in the user interface when the chosen values of the input fields are not valid.
